(19) United States
(12) Patent Application Publication
(10) Pub. No.: US 2011/0299118 A1
(43) Pub. Date: Dec. 8, 2011

(54) IMAGE FORMING SYSTEM, CONTROL METHOD THEREFOR, RECORDING MEDIUM STORING CONTROL PROGRAM THEREFOR, AND INFORMATION PROCESSING APPARATUS

(75) Inventor: Hideo ASAHARA, Yokohama-shi (JP)

(73) Assignee: CANON KABUSHIKI KAISHA, Tokyo (JP)

(21) Appl. No.: 13/150,864

(22) Filed: Jun. 1, 2011

(30) Foreign Application Priority Data
Jun. 3, 2010 (JP) 2010-127786

(51) Int. Cl. G06K 15/00

(52) U.S. Cl. 358/1.15

(57) ABSTRACT

A technique to give a more suitable screen to a user even when functions that can be executed by an image forming apparatus are provided by a linked external apparatus. A comparison unit of the external apparatus compares information about first functions of the external apparatus with information about second functions of the image forming apparatus. A determination unit of the external apparatus determines functions used by the image forming apparatus among the first functions based on a comparison result. A screen information sending unit of the external apparatus sends screen information used for setting the functions determined to the image forming apparatus. A functional information sending unit of the image forming apparatus sends the information about the second function to the external apparatus. A display unit of the image forming apparatus displays a screen for setting the first functions based on the screen information received from the external apparatus.

### BACKGROUND OF THE INVENTION

1. Field of the Invention

The present invention relates to an image forming system in which an external apparatus executes a part of an image process applied to image data that is formed by an image forming apparatus, a control method therefor, a recording medium storing a control program therefor, and an information processing apparatus.

2. Description of the Related Art

Some conventional image forming apparatuses have a plurality of print functions, such as an N-in-1 copy function that collects images on originals and prints them into one recording sheet, an insertion function that prints images while inserting an insertion sheet between specific pages, and a composition function that composes an original image with a specific image and outputs the composed image. The image forming apparatuses can singly print by combining a plurality of print functions represented by the above-mentioned functions. As compared with this, a printing system that achieves a print function that is not provided by an image forming apparatus using an external apparatus is proposed.

For example, the image forming apparatus disclosed in Japanese Laid-Open Patent Publication (Kokai) No. 2003-288336 (JP 2003-288336A) sends a request of “2-in-1 copy” and image data of inputted originals to an external apparatus when a user designates the “2-in-1 copy” through an operation panel of the image forming apparatus. The external apparatus applies a 2-in-1 process to the image data received. Then, the external apparatus sends back the processed image data to the image forming apparatus, and the image forming apparatus prints the processed image data.

On the other hand, Japanese Laid-Open Patent Publication (Kokai) No. 2008-139981 (JP 2008-139981A) discloses a technique where a Web page acquired from an external apparatus is displayed on an operation panel of an image forming apparatus and various applications stored in the external apparatus are executed in response to operations on the Web page. In this case, an image formation program held in the image forming apparatus operates with linking to these applications. For example, a translation application will operate as follows. First, the application of the external apparatus instructs to generate a scan job to the image forming apparatus after a user inputs necessary parameters on the Web page. Then, the application receives an original image read by the image forming apparatus. The translation application applies an OCR process and a translation process to the received original image, and then, instructs to generate a print job to the image forming apparatus. The image forming apparatus prints the image data received from the external apparatus.

Thus, JP 2008-139981A achieves the print function that the image forming apparatus does not have by executing a print application on the external apparatus.

However, the above-mentioned conventional techniques may provide a function with which the image forming apparatus is already provided by the external apparatus. In such a case, a user can designate the same function in different screens, which confuse the user. When the user mistakenly uses a pay function that is provided by the external apparatus even if the same function is provided by the image forming apparatus, the user is charged in vain.

When the function with which the image forming apparatus is provided and the function by which the external apparatus is provided overlap one another but the versions of the functions are different, simple access control to one function cannot solve the above problem, because the user generally wants to use a function with a newer version.

### SUMMARY OF THE INVENTION

The present invention provides a technique to give a more suitable screen to a user even when a function that can be executed by an image forming apparatus is provided by a linked external apparatus.

Accordingly, a first aspect of the present invention provides an image forming system comprising an external apparatus provided with first functions and an image forming apparatus capable of connecting to the external apparatus via a network. The external device comprises a comparison unit configured to compare information about the first functions with information about second functions with which an image forming apparatus is provided, a determination unit configured to determine functions to be used by the image forming apparatus among the first functions based on a comparison result by the comparison unit, and a screen information sending unit configured to send screen information that is used for setting the functions determined by the determination unit to the image forming apparatus. The image forming apparatus comprises a functional information sending unit adapted to send the information about the second function with which the image forming apparatus is provided to the external apparatus, and a display unit adapted to display a setting screen for setting the first functions based on the screen information received from the external apparatus.

Accordingly, a second aspect of the present invention provides a control method for an image forming system comprising a comparison step, executed by an external apparatus that is provided with first functions, of comparing information about the first functions with information about second functions with which an image forming apparatus is provided, a determination step, executed by the external apparatus, of determining functions to be used by the image forming apparatus among the first functions based on a comparison result in the comparison step, a screen information sending step, executed by the external apparatus, of sending screen information that is used for setting the functions determined in the determination step to the image forming apparatus, an information sending step, executed by the image forming apparatus, of sending the information about the second function with which the image forming apparatus is provided to the external apparatus, and a display step, executed by the image forming apparatus, of displaying a setting screen for setting the first functions based on the screen information received from the external apparatus.

Accordingly, a third aspect of the present invention provides an external apparatus provided with first functions comprising a comparison unit configured to compare information about the first functions with information about second functions with which an image forming apparatus is provided, a determination unit configured to determine functions to be used by the image forming apparatus among the first functions based on a comparison result by the comparison unit, and a screen information sending unit configured to send screen information that is used for setting the functions determined by the determination unit to the image forming apparatus.

Accordingly, a fourth aspect of the present invention provides an information processing apparatus provided with public functions that can be used by another apparatus and capable of communicating via a network with an image forming apparatus that can singly provide client functions to a user, comprising a comparison unit configured to compare information about the public functions with information about the client functions received from the image forming apparatus, a registration unit configured to register a first public function of a newer version among the public functions corresponding to the client functions based on the comparison result by the comparison unit, and a screen information sending unit configured to add screen information for setting details of the first public function to the information about the first public function registered by the registration unit, and to send it to the image forming apparatus.

According to the present invention, the more suitable screen can be provided to the user even when a function that can be executed by the image forming apparatus is provided by the linked external apparatus. More specifically, the present invention makes the user select a screen using a newer function.

Further features of the present invention will become apparent from the following description of exemplary embodiments with reference to the attached drawings.

### BRIEF DESCRIPTION OF THE DRAWINGS

FIG. 1 is a block diagram schematically showing the entire configuration of an image forming system and hardware configurations of apparatuses in the system according to a first embodiment of the present invention.

FIG. 2 is a block diagram schematically showing software configurations of an external apparatus and an image forming apparatus that constitute the image forming system in FIG. 1.

FIG. 3 is a view showing examples of detailed setting screens of various functions displayed when the image forming apparatus executes a copy job.

FIG. 4A is a view showing an example of information about a client function with which the image forming apparatus in FIG. 1 is provided.

FIG. 4B is a view showing an example of information about a public function that the external apparatus in FIG. 1 provides.

FIG. 5A is a view showing an example of a comparison result list notified to the image forming apparatus in FIG. 1.

FIG. 5B is a view showing an example of a comparison result list for the external apparatus in FIG. 1.

FIG. 6A is a flowchart showing one part of a process flow when executing a copy job in the image forming apparatus in FIG. 1.

FIG. 6B is a flowchart showing the other part of the process flow when executing the copy job in the image forming apparatus in FIG. 1.

FIG. 7 is a flowchart showing details of a first extension mode setting process executed in step S1008 in FIG. 6B.

FIG. 8 is a flowchart showing details of a second extension mode setting process executed in step S1012 in FIG. 6B.

FIG. 9 is a flowchart showing details of a printing process executed in the step S1016 in FIG. 6A.

FIG. 10 is a flowchart showing a function comparison process in the external apparatus in FIG. 1.

FIG. 11 is a flowchart showing a Web page generation process in the external apparatus in FIG. 1.

FIG. 12 is a flowchart showing a public function executing process in the external apparatus in FIG. 1.

### DESCRIPTION OF THE EMBODIMENTS

Hereafter, embodiments according to the present invention will be described in detail with reference to the drawings.

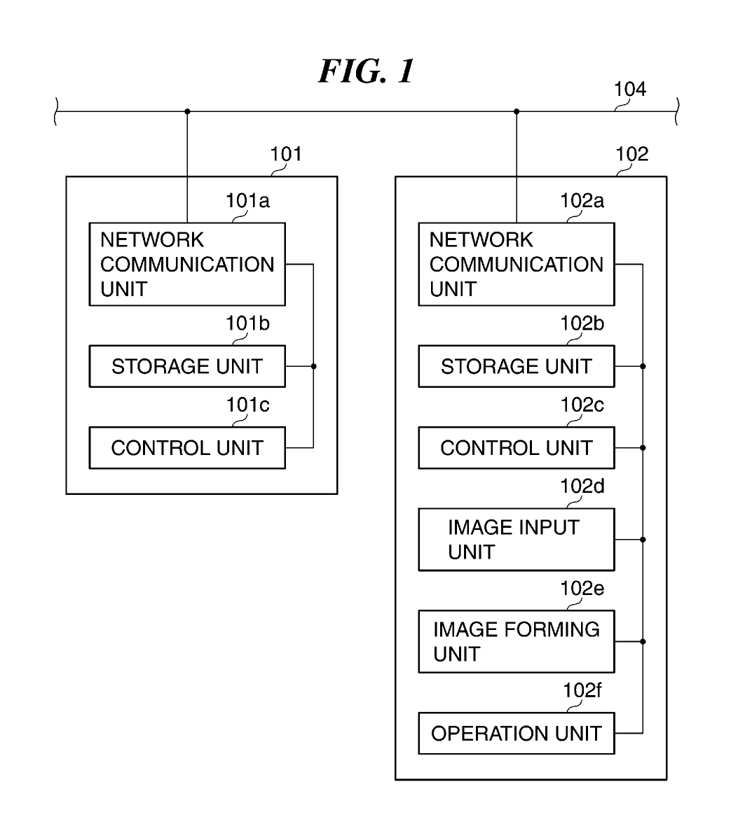

FIG. 1 is a block diagram schematically showing the entire configuration of an image forming system and hardware configurations of apparatuses in the system according to a first embodiment of the present invention.

The image forming system of this embodiment comprises an information processing apparatus (referred to as an “external apparatus”) 101 and an image forming apparatus 102 that can communicate with the external apparatus 101 via a network 104, for example, as shown in FIG. 1. The information processing apparatus comprises a personal computer (PC), and the image forming apparatus 102 comprises a multifunctional peripheral device. The networks 104 may be local networks such as a cable LAN and a wireless LAN, or may be a global network like the Internet.

The external apparatus 101 is provided with a control unit 101c that comprises a CPU, a storage unit 101b that comprises a ROM, a RAM, a HDD, etc., and a network communication unit 101a that is a network I/F, like a common PC. Then, the external apparatus 101 achieves a function of each unit by making the CPU read programs, image data required for each program, and Web page contents, which are stored in the HDD, onto the RAM and execute them.

The network communication unit 101a connects with the network 104, and sends/receives image data, a Web page, etc. to/from another apparatus (not shown) on the network. The storage unit 101b stores Web page contents, image data, and information about a job set value (a second job set value mentioned later).

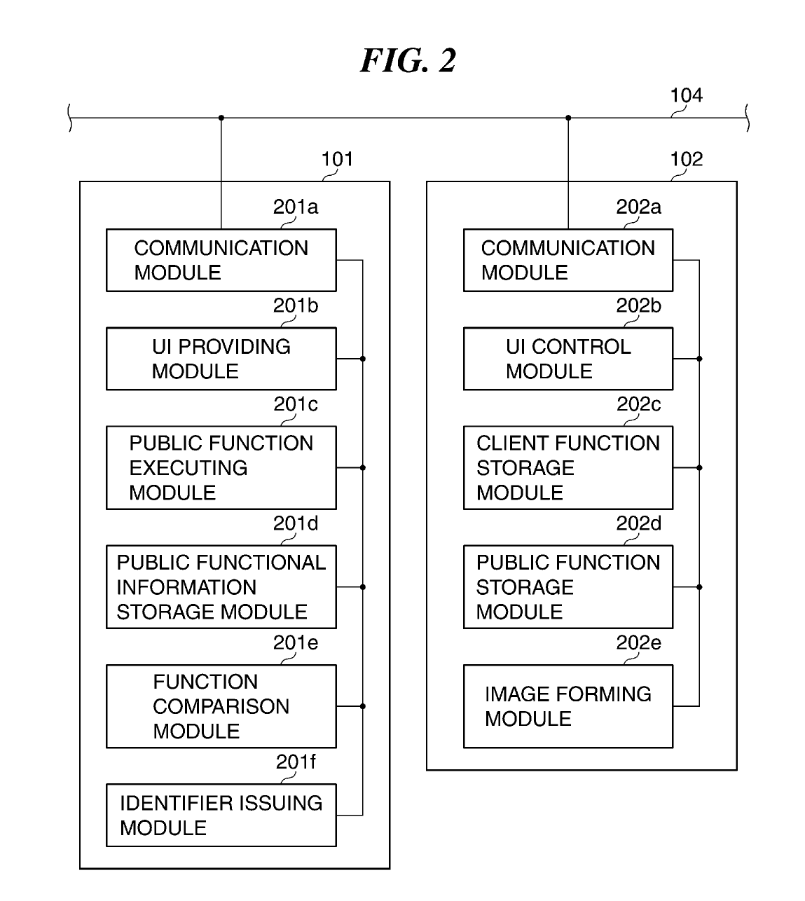

The control unit 101c executes a control program read from the storage unit 101b. The control program includes software required to achieve a function of each module in FIG. 2 mentioned later. The network communication unit 101a, the storage unit 101b, and the control unit 101c shown in FIG. 1 are mutually connected via a system bus.

The image forming apparatus 102 is provided with a control unit 102c that comprises a CPU, a storage unit 102b that comprises a ROM, a RAM, a HDD, etc., and a network communication unit 102a that is a network I/F. The image forming apparatus 102 is provided with an image input unit 102d that comprises an optical scanner, an image forming unit 102e, and an operation unit 102f that is a user interface (UI) for a user who operates the image forming apparatus 102. Then, the image forming apparatus 102 achieves a function of each unit by making the CPU read programs, image data required for each program, and screen resources, which are stored in the HDD, onto the RAM and execute them.

The network communication unit 102a connects with the network 104, and sends/receives image data, a Web page, etc. to/from the external apparatus 101. The storage unit 102b stores image data and information about a job set value (a first job set value mentioned later).

The control unit 102c executes a control program read from the storage unit 102b. The control program includes software required to execute each module in FIG. 2 mentioned later.

The image input unit 102d is provided with a function that reads image data from an original. The image forming unit 102e is provided with a printing function that forms an image on a recording sheet. The operation unit 102f comprises a liquid crystal touch panel, for example. The units 102a through 102f are mutually connected via a system bus.

FIG. 2 is a block diagram schematically showing software configurations of the external apparatus 101 and the image forming apparatus 102 that constitute the image forming system in FIG. 1.

First, the software configuration of the external apparatus 101 will be described.

A communication module 201a has a function to perform data communication with a communication module 202a in the image forming apparatus 102 via the network communication unit 101a. The concrete content of the data communication by the communication module 201a will be clarified in the following description of each module.

A UI providing module 201b has a function to provide user-interface (UI) information for a user to perform a detailed setting required to perform a public function by the external apparatus 101.

The public function that the external apparatus 101 provides is described. In this embodiment, the public function means a certain software process that another external apparatus can use. Specifically, the public functions are processes to perform a page printing composition, a form composition, an image movement, a QR code embedding, etc. by the external apparatus 101, which are applied to the image data sent from the image forming apparatus 102. It should be noted that the public function is not limited to a software process that processes image data. For example, the public functions include software processes of transferring data to a specific device and of starting other software.

The screen information provided by the UI providing module 201b means information about a detailed setting screen for performing the form composition, for example. The screen information is provided in a form of a Web page. A user who uses the public function can set details on the Web page of the detailed setting screen for the public function displayed by the Web browser.

When receiving an execution instruction for the public function from the image forming apparatus 102 (the user thereof) via the communication module 201a, a public function executing module 201c executes the public function concerned. The public function to execute is designated by a URL. A public functional information storage module 201d mentioned later stores the information about the detailed setting that is needed to execute the public function to the storage unit 101b for each identifier. Therefore, the public function executing module 201c reads detailed setting information based on the identifier received together with the execution instruction of a public function, and executes a public function with reference to this detailed setting information.

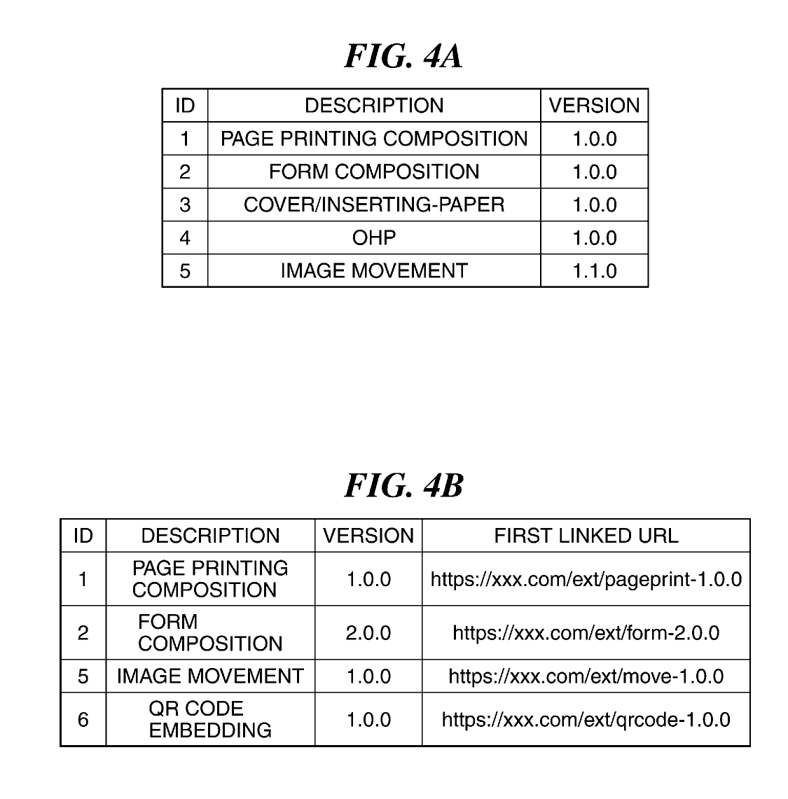

The public functional information storage module 201d has a function to store the information about the public function that is provided by the external apparatus 101 to the storage unit 101b. The information about the public function includes the information about the public function, the software to execute the public function, and the detailed setting information about the above-mentioned public function. An example of the information about the public function that the external apparatus 101 provides is shown in FIG. 4B.

In FIG. 4B, the information about the public function comprises an ID to identify the function uniquely, a description of the function, a version of the function, and a first linked URL that indicates a location where the screen information for performing detailed setting of the function is saved. The detailed setting information of the public function is stored in the storage unit 101b for each identifier issued by an identifier issuing module 201f mentioned later. The detailed setting information of the public function stored in the public functional information storage module 201d is deleted after a lapse of predetermined time.

A function comparison module 201e has a function to compare and determine the public function that the external apparatus 101 provides and a client function with which the image forming apparatus 102 is provided. The client function means a function that the image forming apparatus 102 solely provides to a user without cooperating with the external apparatus 101. For example, the client functions include processes for a page printing composition, a form composition, cover/inserting-paper, an OHP, an image movement.

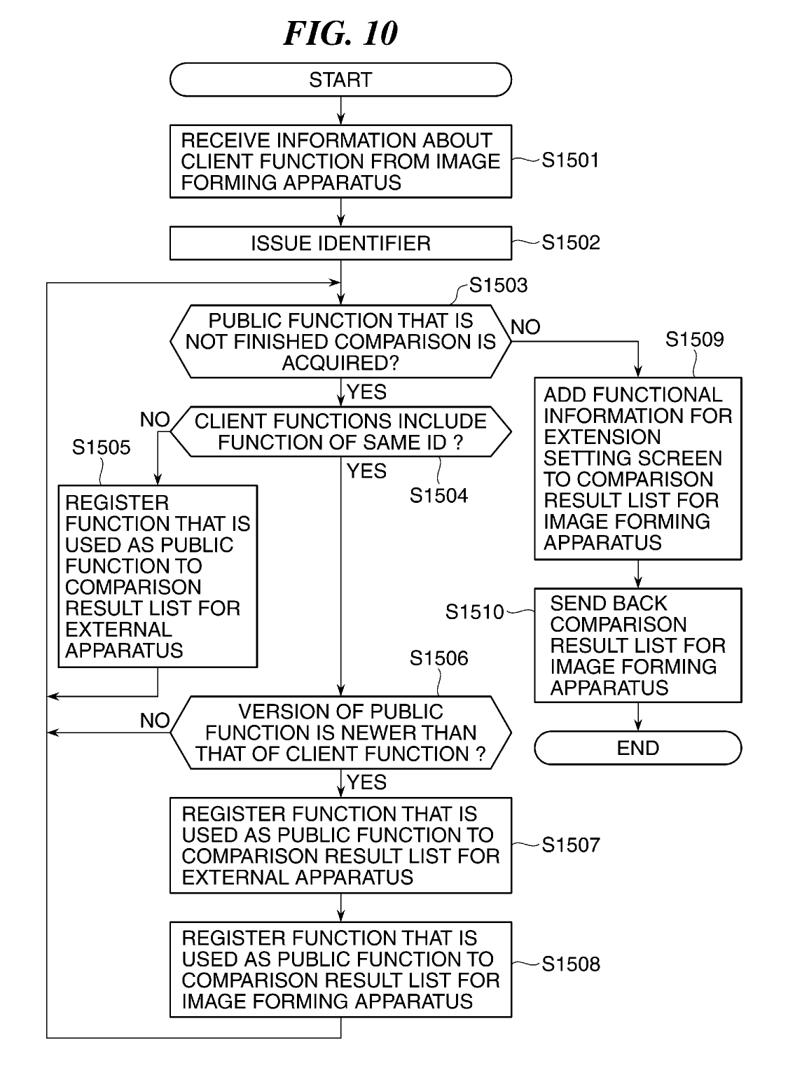

The function comparison module 201e compares the public function that is provided by the external apparatus 101 with the client function with which the image forming apparatus 102 is provided, and determines to use the public function when the function is provided by the public function only. On the contrary, when the function is provided by the client function only, the module 201e determines to use the client function. When the same function is provided by both of the public function and the client function, the module 201e compares the versions of the functions, and determines to use a function of newer version. The function comparison by the function comparison module 201e will be described in detail with reference to FIG. 10.

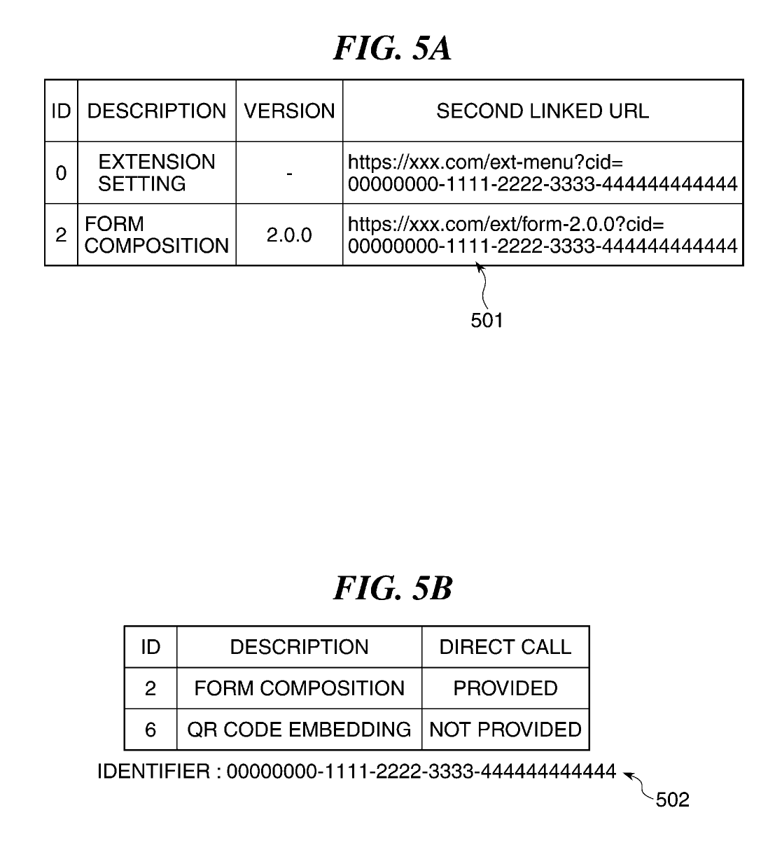

The information acquired from the comparison result by the function comparison module 201e is defined as a comparison result list. The comparison result list gives two kinds of information. One comparison result list is stored in the storage unit 101b by the public functional information storage module 201d and is referred to by the external apparatus 101. The other comparison result list is stored in the storage unit 102b by the public function storage module 202d and is referred to by the image forming apparatus 102. The former comprises a list of functions that the external apparatus 101 determines to send to the image forming apparatus 102, and is called a comparison result list for the external apparatus. FIG. 5B shows an example of the comparison result list for the external apparatus. The latter comprises a list of functions that are provided by the external apparatus 101 and are used by the image forming apparatus 102, and is called a comparison result list for the image forming apparatus. FIG. 5A shows an example of the comparison result list for the image forming apparatus.

The identifier issuing module 201f has a function to issue a unique identifier for identifying a user who uses the public function uniquely. In this embodiment, a UUID (Universally Unique IDentifier) is issued as an identifier.

Next, the software configuration of the external apparatus 102 will be described.

The communication module 202a has a function to perform data communication with the communication module 201a in the external apparatus 101 via the network communication unit 102a. The concrete content of the data communication by the communication module 202a will be clarified in the following description of each module.

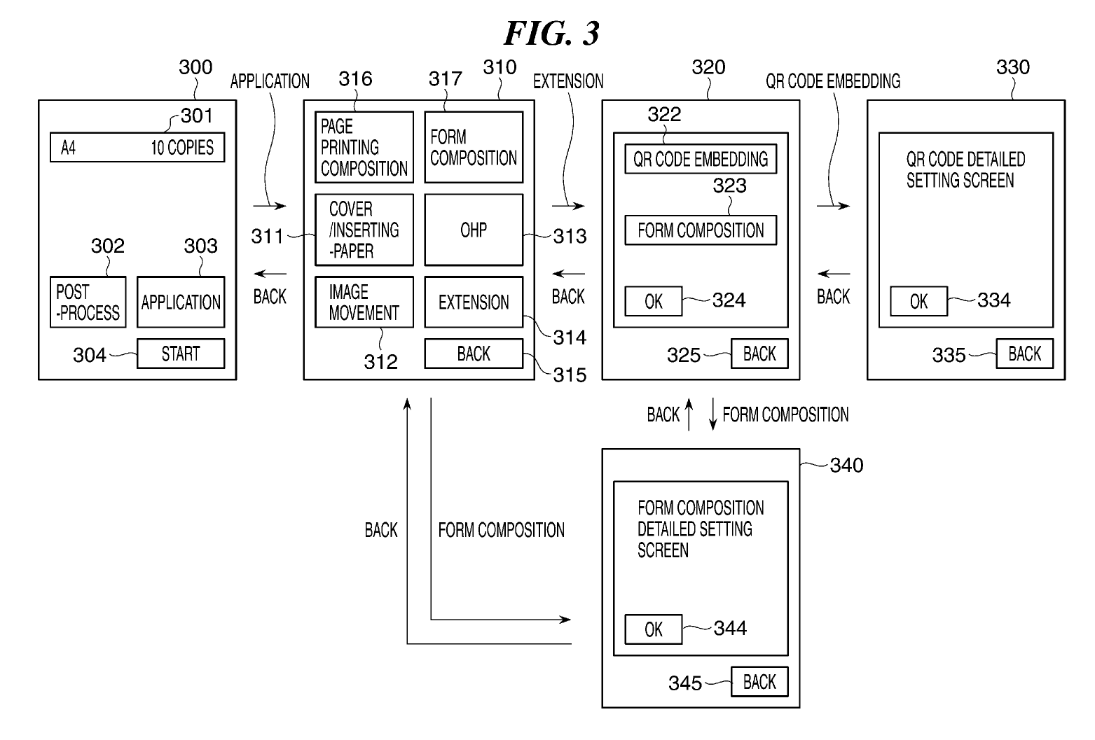

A UI control module 202b has a function to provide a predetermined user interface for the user of the image forming apparatus 102 by using the operation unit 102f. The function of the UI control module 202b will be described in detail with reference to FIG. 3.

A client function storage module 202c has a function to store the information about the client function that the image forming apparatus 102 solely provides for a user in the storage unit 102b. FIG. 4A shows an example of the information about the client function stored by the client function storage module 202c.

As shown in FIG. 4A, the information about the client function comprises three parts including an ID for identifying the function uniquely, a description of the function, and a version of the function. The ID is a unique number assigned in common to the client function and the public function, and the same number is allocated to the same function. The description of the function is information about contents of the function to provide. The version of the function is a version number of the function to provide. The version number comprises a combination of three numbers, the upper digit shows a major version, the middle digit shows a minor version, and the lower digit shows a build version. There is a difference between different versions of the same function.

The public function storage module 202d has a function to store the information about the comparison result list for the image forming apparatus that is the comparison result compared by the function comparison module 201e to the storage unit 102b. The image forming module 202e has an image forming function that is executed by the control unit 102c using the image forming unit 102e based on the image data inputted from the image input unit 102e.

Next, a copy job executing process in the image forming apparatus 102 will be described.

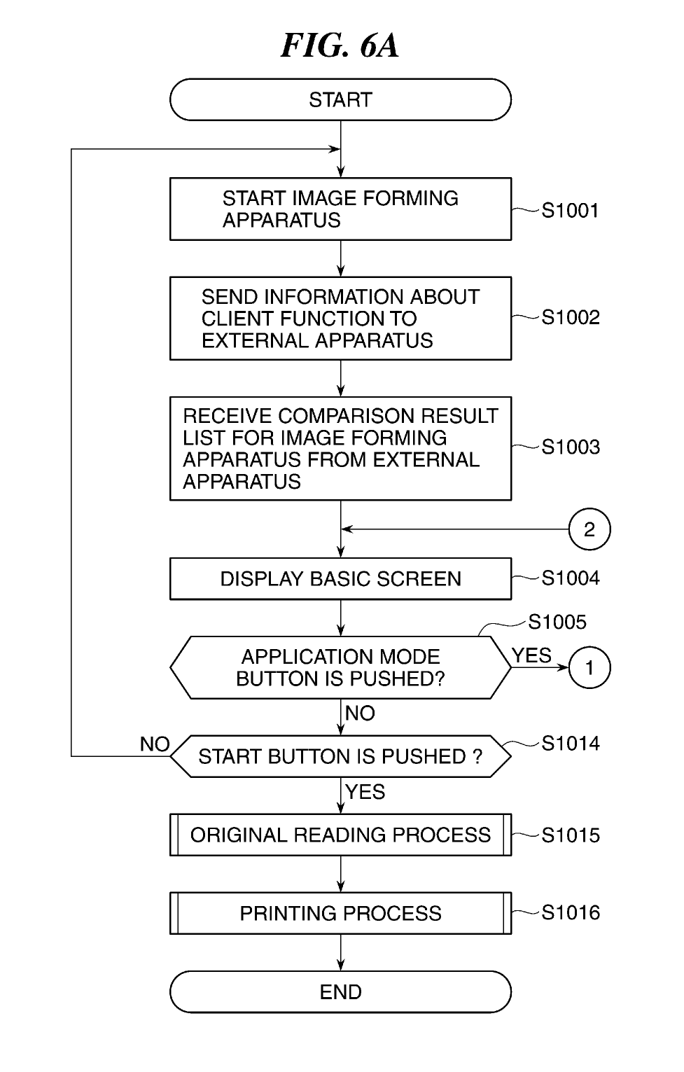

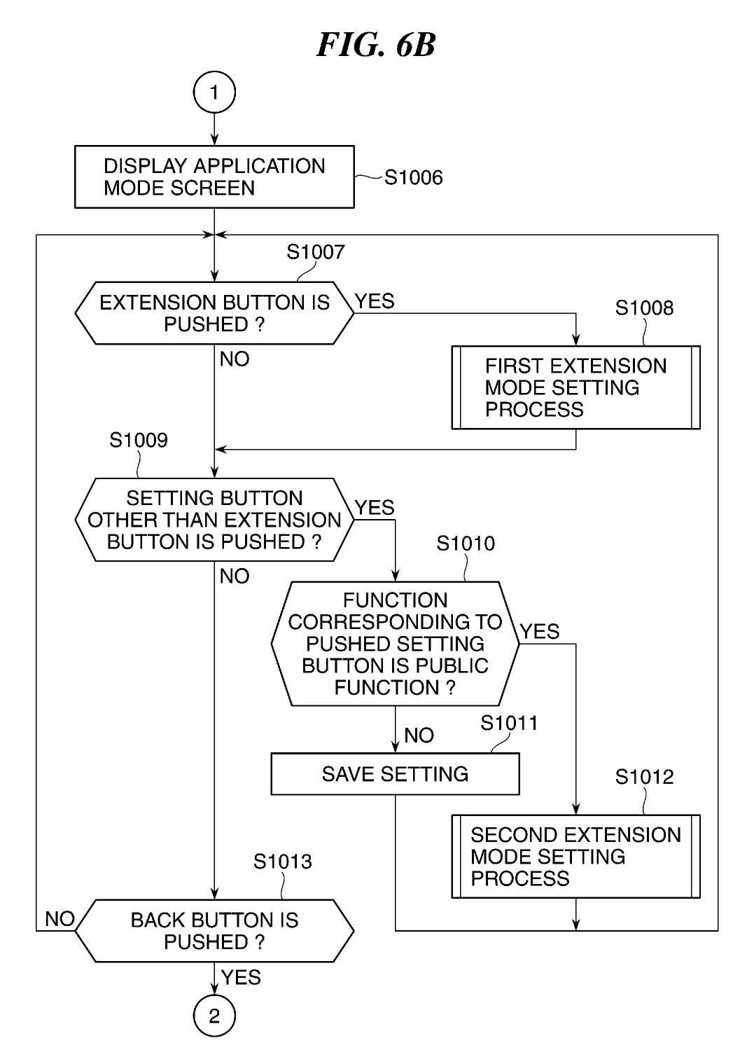

FIG. 6A and FIG. 6B are flowcharts showing the copy job executing process in the image forming apparatus 102.

In step S100, a user's operation starts the image forming apparatus 102. Next, in step S1002, the communication module 202a reads the information about the client function as shown in FIG. 4A from the storage unit 102b, and sends it to the external apparatus 101.

Next, in step S1003, the communication module 202a receives the comparison result list for image forming apparatus as shown in FIG. 5A from the external apparatus 101. The public function storage module 202d stores the received information in the storage unit 102b.

In FIG. 5A, descriptions for three points including an ID, a description, and a version are omitted because they are identical to that in FIG. 4A. A second linked URL is information that shows an access destination for using the public function of the external apparatus 101 from the image forming apparatus 102. The second linked URL corresponding to the public function of which ID is “0” gives the UUID as “cid” behind the question mark. This UUID is the identifier issued by the identifier issuing module 201f.

In step S1004 in FIG. 6A, the UI control module 202b displays a basic screen 300 shown in FIG. 3 on the operation unit 102f. Here, examples of the detailed setting screens for the public function and the client function that are displayed on the operation unit 102f by the UI control module 202b will be described with reference to FIG. 3.

In FIG. 3, the basic screen 300 is displayed on the operation unit 102f by the UI control module 202b before executing a job. On the basic screen 300, a size-and-number-of-copies display section 301, a post-process button 302, an application button 303, and a start button 304 are arranged. The size-and-number-of-copies display section 301 displays a sheet size that a user has set on a paper selection screen (not shown) and the number of copies that the user has set by ten key buttons (not shown). In the illustrated example, “A4” and “10 copies” are displayed as the sheet size and the number of copies. The post-process button 302 is used for setting post-processes (sorting, stapling, etc.). When the post-process button 302 is pushed, a post-process setting screen (not shown) is displayed, and the details of the post-process can be set. The application button 303 is used for displaying an application mode screen 310. A push of the start button 304 starts a copy job.

In step S1005 in FIG. 6A, the UI control module 202b determines whether the application button 303 has been pushed. When the application button 303 has been pushed, the process proceeds to step S1006 (FIG. 6B). When the button 303 has not been pushed, the process proceeds to step S1014.

In the step S1006 in FIG. 6B, the UI control module 202b displays the application mode screen 310 shown in FIG. 3 on the operation unit 102f. The application mode screen 310 is displayed on the operation unit 102f by the UI control module 202b based on screen resource information read from the storage unit 102b. Job setting to the image data inputted from the image input unit 102d on the screen is performed.

On the application mode screen 310, a cover/inserting-paper button 311, an image movement button 312, an OHP button 313, an extension button 314, a back button 315, a page printing composition button 316, and a form composition button 317 are arranged. Thus, on the application mode screen 310, the setup buttons that are used to set details of the client functions with which the image forming apparatus is provided are arranged.

In step S1007, the UI control module 202b determines whether the extension button 314 has been pushed. When the extension button 314 has been pushed, the process proceeds to step S1008. When the button 314 has not been pushed, the process proceeds to step S1009.

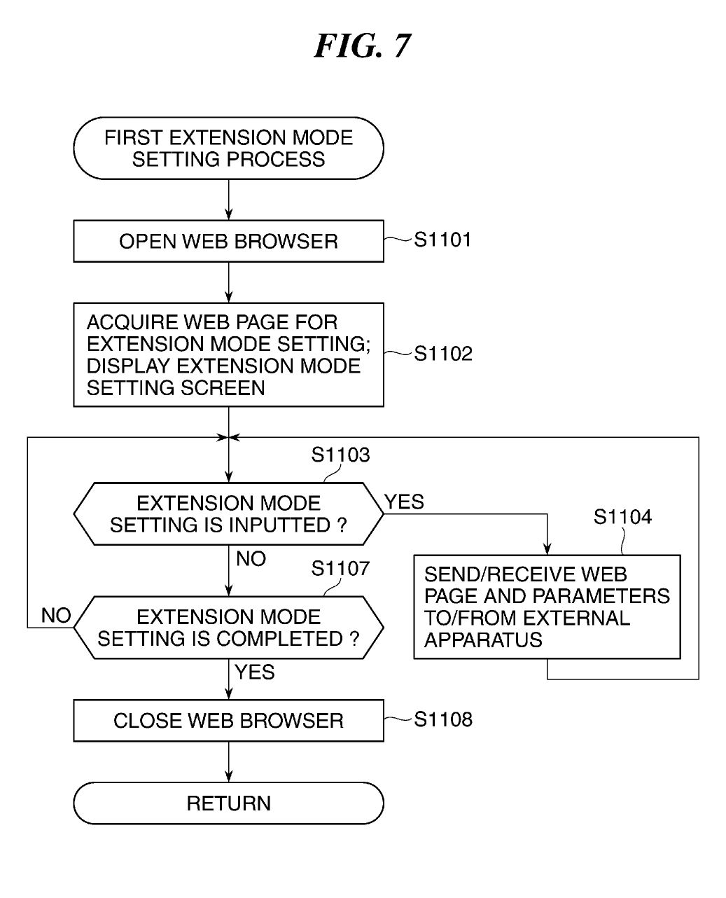

In the step S1008, the UI control module 202b displays an extension mode setting screen 320 shown in FIG. 3 on the operation unit 102f, and sets a second job set value about the public function that the external apparatus 101 provides (a first extension mode setting process). Details of the process will be described with reference to FIG. 7.

Next, in the step S1009, the UI control module 202b determines whether a setting button other than the extension button 314 has been pushed. When a button other than the extension button 314 has been pushed, the process proceeds to step S1010. When a button other than the extension button 314 has not been pushed, the process proceeds to step S1013.

In the step S1010, the UI control module 202b acquires an ID of the function corresponding to the pushed setting button, and determines whether the function has been stored in the storage unit 102b by the public function storage module 202d. The functions that have been stored in the storage unit 102b by the public function storage module 202d are included in the comparison result list for the image forming apparatus as shown in FIG. 5A. That is, the functions except for the extension setting are supported by both of the external apparatus 101 and the image forming apparatus 102, but are set to be provided by the external apparatus 101. When the storage unit 102b stores information about the function of the same ID, the process proceeds to step S1012. When it does not store, the process proceeds to step S1011. For example, when the storage unit 102b stores the information about the functions as shown in FIG. 5A, a push of the form composition button 317 proceeds with the process to the step S1012 and a push of another button proceeds with the process to the step S1011.

In the step S1011, the UI control module 202b displays a detailed setting screen (not shown) corresponding to a setting button pushed in the step S1009, and stores settings that are set on the detailed setting screen concerned into the storage unit 102b. The settings stored here are used as the first job set value. For example, when the cover/inserting-paper button 311 is pushed, a cover/inserting-paper setting screen (not shown) is displayed, and a user can set presence or absence of a cover and a sheet number to which an inserting paper will be inserted among printed sheets. When the image movement button 312 is pushed, an image-movement setting screen (not shown) is displayed, and the user can select a position of image data to be printed from among the center, the upper right, the upper left, the lower right, and the lower left in the sheet. When the OHP button 313 is pushed, an OHP setting screen (not shown) is displayed, and the user can set whether an insertion paper is outputted as a blank sheet or a printed sheet. In the later case, the same image data as that printed on an OHP will be printed on the insertion paper at the time of an OHP printing. When the page printing composition button 316 is pushed, a page printing composition screen (not shown) is displayed, and the user can set a position of page number to be printed, a format, etc.

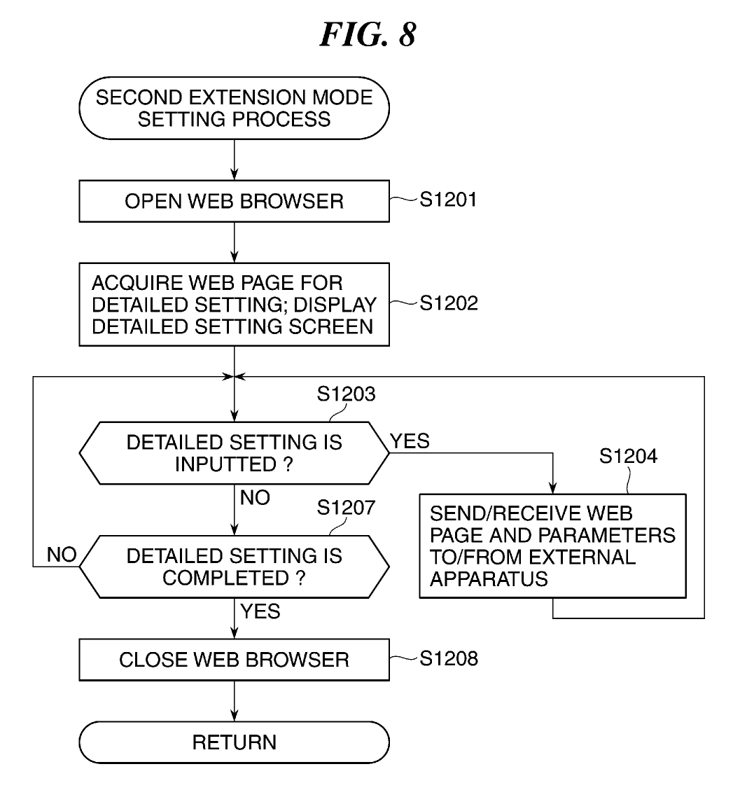

In the step S1012, the UI control module 202b displays a detailed setting screen in response to the setting button pushed in the step S1009, and sets a second job set value about the public function that the external apparatus 101 provides (a second extension mode setting process). Details of the process will be described with reference to FIG. 8.

In step S1013, the UI control module 202b determines whether the back button 315 has been pushed. When the back button 314 has been pushed, the process returns to the step S1004 in FIG. 6A. When the button 315 has not been pushed, the process returns to the step S1007.

Thus, the first job set value and the second job set value are set.

In step S1014 in FIG. 6B, the UI control module 202b determines whether the start button 304 for the copy job on the operation unit 102f has been pushed. When the start button 304 for the copy job has been pushed, the process proceeds to step S1015. When the button 304 has not been pushed, the process returns to the step S1001.

In the step S1015, the image forming module 202e controls the image input unit 102d to start reading an original, and stores the image data read into the storage unit 102b (an original reading process).

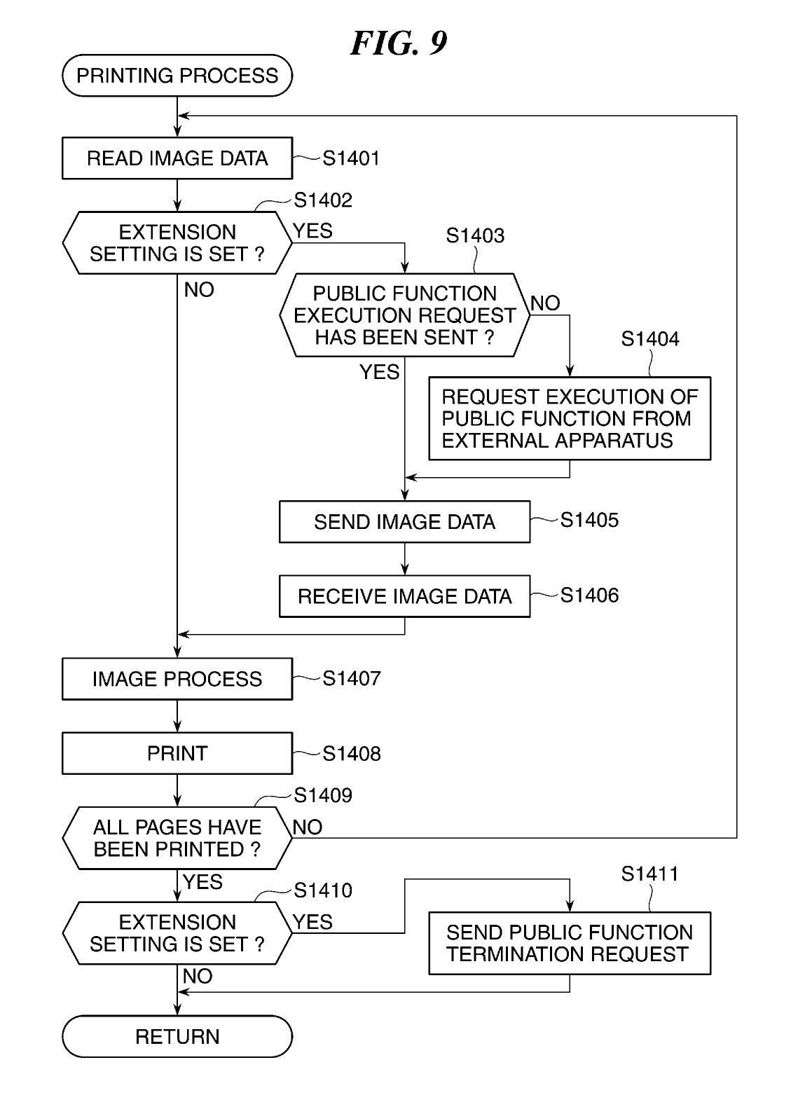

In step S1016, the image forming module 202e makes the image forming unit 102e start printing, and controls to read the image data from the storage unit 102b and to print (a printing process). Details of the process will be described with reference to FIG. 9.

FIG. 7 is a flowchart showing details of the first extension mode setting process executed in the step S1008 in FIG. 6B.

In step S1101, the UI control module 202b starts a Web browser. Next, in step S1102, the UI control module 202b requests a Web page of an extension mode setting screen from the Web server module (not shown) that operates on the external apparatus 101. Then, as shown in FIG. 3, the Web page of the extension mode setting screen 320 acquired from the external apparatus 101 is displayed on the operation unit 102f by the Web browser. The extension mode setting screen 320 is used for setting details of the public function obtained from the comparison result by the function comparison module 201e, and includes a QR code embedding button 322, a form composition button 323, an OK button 324, and a back button 325a.

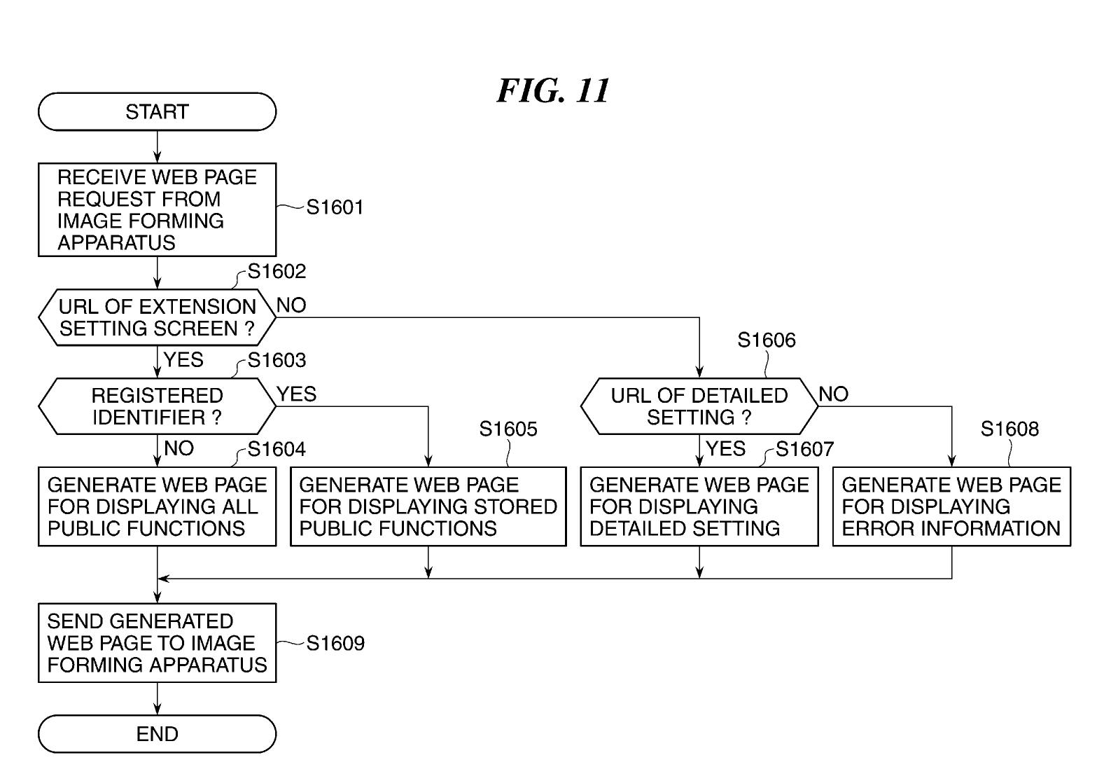

When the UI control module 202b requests the Web page of the extension mode setting screen, the second linked URL of the extension setting function that “0” is allocated to the ID is used as shown in FIG. 5A. The identifier embedded to the second linked URL is notified to the external apparatus 101 from the image forming apparatus 102. The generation process of the Web page sent to the image forming apparatus 102 from the external apparatus 101 will be described with reference to FIG. 11.

Next, in step S1103, the UI control module 202b determines whether the user has taken any input operation by pushing a button arranged on the extension mode setting screen 320. In this determination, when the QR code embedding button 322 or the form composition button 323 has been pushed on the extension mode setting screen 320, it is determined that the user has taken the input operation, and the process proceeds to step S1104, for example. When these buttons have not pushed, the process proceeds to step S1107.

In the step S1104, the UI control module 202b receives the Web page corresponding to the pushed button from the external apparatus 101, displays the screen by the Web browser, sends parameters inputted via the displayed screen to the external apparatus 101, and returns the process to the step S1103. For example, when it is determined that the form composition button 323 has pushed in the step S1103, the UI control module 202b requests the Web page of the form composition detailed setting screen 340 from the external apparatus 101. Then, as shown in FIG. 3, the acquired Web page of the form composition detailed setting screen 340 is displayed on the operation unit 102f. When the user finishes the setting and pushes the OK button 344, the communication module 202a sends the information about the settings and the identifier to the external apparatus 101 as parameters. The public functional information storage module 201d of the external apparatus 101 stores the received information about the settings associated with the identifier into the storage unit 101b. The settings stored here are used as the second job set value. When the back button 345 is pushed, the UI control module 202b changes the screen to the extension mode setting screen 320 without sending parameters to the external apparatus 101, and returns the process to the step S1103.

Similarly, when the QR code embedding button 322 is pushed in the step S1103, the UI control module 202b requests the Web page of the QR code detailed setting screen 330 from the external apparatus 101 in the step S1104. Then, as shown in FIG. 3, the Web page of the acquired QR code detailed setting screen 330 is displayed on the operation unit 102f. When the user finishes the setting and pushes the OK button 334, the UI control module 202b sends the about the settings and the identifier to the external apparatus 101 as parameters. The public functional information storage module 201d of the external apparatus 101 stores the received information about the settings associated with the identifier into the storage unit 101b. The settings stored here are also used as the second job set value. When the back button 335 is pushed, the UI control module 202b changes the screen to the extension mode setting screen 320 without sending parameters to the external apparatus 101, and returns the process to the step S1103.

In step S1107, the UI control module 202b determines whether the setting of the extension mode has been completed. That is, it is determined whether the back button 325 has been pushed on the extension mode setting screen 320. When pushed, the process proceeds to step S1108. When not pushed, the process returns to the step S1103.

In the step S1108, the UI control module 202b finishes the Web browser, changes the screen from the extension mode setting screen 320 to the application mode screen 310, and returns the process to FIG. 6B.

FIG. 8 is a flowchart showing details of the second extension mode setting process executed in the step S1012 in FIG. 6B.

In step S1201, the UI control module 202b starts a Web browser. Next, in step S1102, the UI control module 202b requests a Web page of a detailed setting screen for various functions from the Web server module (not shown) that operates on the external apparatus 101. Then, as shown in FIG. 3, the Web page of the form composition detailed setting screen 340 acquired from the external apparatus 101 is displayed on the operation unit 102f by the Web browser.

When the UI control module 202b requests the Web page of the detailed setting screen, the second linked URL corresponding to the ID of the function allocated to the setting button pushed in the step S1009 is used. For example, when the form composition button 317 is pushed in the step S1009, since the ID of the allocated function is “2”, the second linked URL corresponding to “ID: 2” shown in FIG. 5A is used. The identifier embedded to the second linked URL is notified to the external apparatus 101 from the image forming apparatus 102. The generation process of the Web page sent to the image forming apparatus 102 from the external apparatus 101 will be described with reference to FIG. 11.

Next, in step S1203, the UI control module 202b determines whether the user has taken any input operation for the detailed setting on the detailed setting screen. In this determination, when the user has set the details on the form composition detailed setting screen 340 shown in FIG. 3, for example, it is determined that the user has taken the input operation, and the process proceeds to step S1204. When there is no input operation, the process proceeds to step S1207.

In the step S1204, the UI control module 202b sends the information about the detailed setting of the extension setting set via the detailed setting screen displayed and the identifier as parameters to the external apparatus 101, and returns the process to the step S1203. For example, when the user finishes the setting on the form composition detailed setting screen 340 and pushes the OK button 344, the information of the settings and the identifier are sent to the external apparatus 101. The public functional information storage module 201d of the external apparatus 101 stores the received information about the settings associated with the identifier into the storage unit 101b. The settings stored here are also used as the second job set value, and is merged to the information stored in the step S1104 in FIG. 7.

In the step S1207, the UI control module 202b determines whether the detailed setting has been completed. That is, it is determined whether the back button has been pushed on the detailed setting screen. When pushed, the process proceeds to step S1208. When not pushed, the process returns to the step S1203. For example, when the back button 345 is pushed on the form composition detailed setting screen 340, it is determined that the detailed setting has been completed, and the process proceeds to the step S1208. When the button 345 is not pushed, the process returns to the step S1203.

In the step S1108, the UI control module 202b finishes the Web browser, changes the screen from the detailed setting screen, such as the form composition detailed setting screen 340, to the application mode screen 310, and returns the process to FIG. 6B.

FIG. 9 is a flowchart showing details of the printing process executed in the step S1016 in FIG. 6A.

In step S1401, the image forming module 202e reads image data from the storage unit 102b. Next, in step S1402, the image forming module 202e determines whether the extension setting is made with reference to the second job set value stored in the storage unit 102b. When the second job set value is stored, it is determined that the extension setting is made. As a result of this determination, when the extension setting is made, the process proceeds to step S1403. When the extension setting is not made, the process proceeds to step S1407.

In the step S1403, the image forming module 202e determines whether a public function execution request has been sent to the external apparatus 101. When the request has not been sent, the process proceeds to step S1404. When the request has been sent, the process proceeds to step S1405.

In the step S1404, the communication module 202a sends the identifier (for example, the identifier shown in FIG. 5B) read from the storage unit 102b to the external apparatus 101, request to execute the public function, and proceeds with the process to step S1405.

In the step S1405, the communication module 202a sends the image data read from the storage unit 102b to the external apparatus 101. Next, in step S1406, the communication module 202a receives the image data to which the image process has been applied by the public function executing module 201c from the external apparatus 101.

In the step S1407, the image forming module 202e applies the image process to the image data (the image data received from the external apparatus when the extension setting is made, or the image data read in the step S1401 when the extension setting is not made) based on the first job set value stored in the storage unit 102b in the step S1011. Next, in step S1408, the image forming module 202e controls the image forming unit 102e so as to print the image data onto the recording sheet. Next, in step S1409, the image forming module 202e determines whether all pages have been printed. When all pages have been printed, the process proceeds to step S1410. When not all pages have been printed, the process returns to the step S1401.

In step S1410, the image forming module 202e determines whether the extension setting is made with reference to the second job set value stored in the storage unit 102b. As a result of this determination, when the extension setting is made, the process proceeds to step S1411. When the extension setting is not made, the process returns to FIG. 6A.

In step S1411, the communication module 202a sends a public function termination request to the external apparatus 101, and returns the process to FIG. 6A.

FIG. 10 is a flowchart showing a function comparison process in the external apparatus 101. This process is executed at the timing between the steps S1002 and S1003 in FIG. 6A executed by the image forming apparatus 102.

In step S1501, the communication module 201a receives the information about the client functions sent from the image forming apparatus 102 in the step S1002. For example, the information about the client functions shown in FIG. 4A is received.

In step S1502, the identifier issuing module 201f issues an identifier for identifying the user who uses a public function according to reception of the client function information from the image forming apparatus 102. For example, the identifier 502 in FIG. 5B is issued. The public function storage module 202d temporarily stores the issued identifier in the storage unit 102b.

In step S1503, the function comparison module 201e determines whether a public function that the function comparison has not finished has been acquired from the storage unit 101b. When the public function has been acquired, the process proceeds to step S1504. When no public function has been acquired, the process proceeds to step S1509. For example, the external apparatus 101 holds the public function shown in FIG. 4B, and can provide it to the image forming apparatus 102.

In the step S1504, the function comparison module 201e determines whether the client function of which the ID is the same as the ID of the public function acquired in the step S1503 is included in the client functions received in the step S1501. When included, the process proceeds to step S1506, and when not included, the process proceeds to step S1505. For example, in step S1504, when the public function is the page printing composing function (ID: 1), the form composing function (ID: 2), or the image moving function (ID: 5), the process proceeds to the step S1506 because the client function having the same ID is given. On the other hand, when the public function is the QR code embedding function (ID: 6), the process proceeds to the step S1505 because no client function having the same ID is given.

In the step S1505, the function comparison module 201e registers the public function (the second public function), which has been determined that no client function having the same ID is not given in the step S1504, to the comparison result list for the external apparatus. At this time, the public functional information storage module 201d stores the public function registered to the comparison result list for the external apparatus into the storage unit 101b in association with the identifier issued in the step S1502 as shown in FIG. 5B. For example, in FIG. 5B, the QR code embedding function (ID: 6) is registered in the step S1505. The public function registered to the comparison result list for the external apparatus is stored into the storage unit 101b in associated with the identifier 502 shown in FIG. 5B issued in the step S1502.

In step S1506 in FIG. 10, the function comparison module 201e compares the versions of the public function and the client function that have the same ID, and determines whether the version of the public function is newer. When the version of the public function is newer, the process proceeds to step S1507. When the version of the public function is older or equivalent, the process returns to the step S1503. For example, since the version of the form composing function (ID: 2) of the public function shown in FIG. 4A is newer than that of the client function shown in FIG. 4B, the process proceeds to the step S1507. On the other hand, since the versions of the page printing composing function (ID: 1) and the image moving function (ID: 5) of the public function are older or equivalent, the process proceeds to the step S1503.

In the step S1507, the function comparison module 201e registers the public function, which has been determined that its version is newer in the step S1506, to the comparison result list for the external apparatus. In the step S1507, as shown in FIG. 5B, the form composing function (ID: 2) is registered into the comparison result list for the external apparatus, for example.

Next, in step S1508, the function comparison module 201e registers the public function (the first public function), which has been determined that its version is newer in the step S1506, to the comparison result list for the image forming apparatus. When registering, the second linked URL that shows the access destination for using the public function of the external apparatus 101 from the image forming apparatus 102 is additionally registered. The second linked URL is simply generated from the information stored into the storage unit 101b by the public functional information storage module 201d, and the identifier issued in the step S1502. In the step S1508, as shown in FIG. 5A, the form composing function (ID: 2) is registered into the comparison result list for the image forming apparatus, for example.

In the step S1509, the function comparison module 201e registers the functional information for the extension setting screens into the comparison result list for the image forming apparatus. The functional information for the extension setting screens is screen information for calling the extension mode setting screen 320 in FIG. 3. Since it is a special function that does not operate during the job execution, it is additionally registered as a special item here. In the step S1509, as shown in FIG. 5A, the extension setting function (ID: 0) is additionally registered to the comparison result list for the image forming apparatus, for example. It should be noted that the ID of “0” is given to neither a public function nor a client function.

In step S1510, the communication module 201a sends back the comparison result list for the image forming apparatus generated according to the above-mentioned process to the image forming apparatus 102. Here, the comparison result list for the image forming apparatus shown in FIG. 5A is sent back.

FIG. 11 is a flowchart showing the Web page generation process in the external apparatus 101. The external apparatus 101 executes this process when the image forming apparatus 102 executes the processes in the step S1102 in FIG. 7 and the step S1202 in FIG. 8.

In step S1601, the communication module 201a receives the Web page request from the image forming apparatus 102. Next, in step S1602, the UI providing module 201b analyzes the requested URL, and determines whether it is a URL of the extension setting screen. That is, when the received Web page request includes the second linked URL of the extension setting function that “0” is allocated to the ID, the second linked URL concerned is analyzed and determined. When the URL of the extension setting screen is included, the process proceeds to step S1603, and when not included, the process proceeds to step S1606.

In the step S1603, the UI providing module 201b acquires an identifier from the second linked URL, and determines whether the same identifier is stored in the storage unit 102b. When the same identifier is stored, the process proceeds to step S1605, and when not stored, the process proceeds to step S1604.

In the step S1604, the UI providing module 201b acquires the information about all the public functions that the external apparatus 101 provides from the storage unit 102b, and generates a Web page of the extension setting screen on which buttons for detailed settings are arranged. It should be noted that the process in the step S1604 is a preparation to an error case, and this process is not performed at a normal time.

In the step S1605, the UI providing module 201b generates a Web page of the extension setting screen that includes buttons for detailed settings of functions applicable to the comparison result list for the external apparatus stored in association with the identifiers. For example, the Web page of the extension mode setting screen 320 that includes the buttons for setting details of the form composing function (ID: 2) and the QR code embedding function (ID: 6) is generated as shown in FIG. 3.

On the other hand, in the step S1602, the UI providing module 201b analyzes the requested URL, and determines whether it is a URL of the extension setting screen for the public function. That is, when the received Web page request includes the second linked URL of the form composing function that “2” is allocated to the ID, the second linked URL concerned is analyzed and determined. When the URL of the detailed setting screen for the public function is included, the process proceeds to step S1607, and when not included, the process proceeds to step S1608.

In the step S1607, the UI providing module 201b analyzes the requested second linked URL, and generates the Web page of the detailed setting screen for the public function designated by the second linked URL concerned. For example, when a URL 501 shown in FIG. 5A is accessed, the Web page of the form composition detailed setting screen 340 shown in FIG. 3 is generated.

In the step S1608, the UI providing module 201b generates a Web page that displays an error message showing that the public function corresponding to the requested URL is not given.

In step S1609, the communication module 201a sends the Web page generated by the above-mentioned process to the image forming apparatus 102 that is the source of access, and finishes this process.

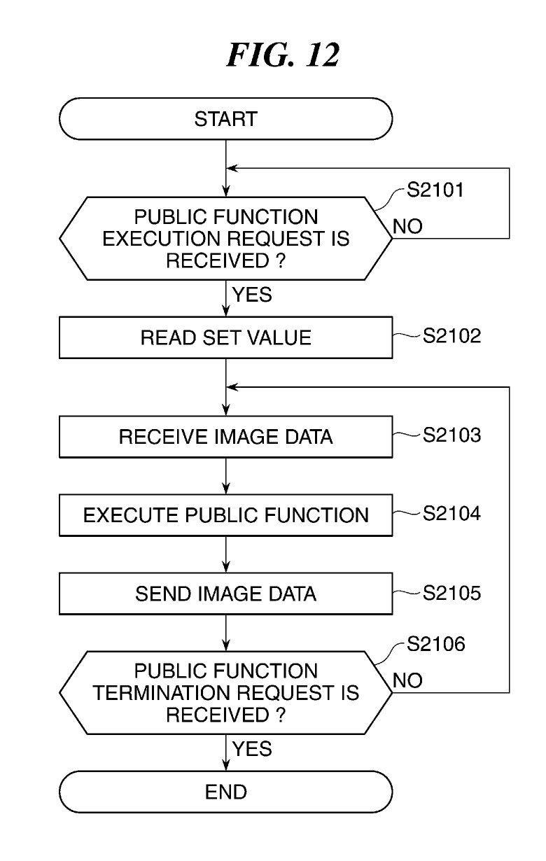

FIG. 12 is a flowchart showing a public function executing process in the external apparatus 101. This process is executed according to the public function execution request that the image forming apparatus 102 sends in the step S1404 in FIG. 9.

In step S2101, the communication module 201a determines whether the public function execution request sent from the image forming apparatus 102 has been received. When received, the process proceeds to step S2102.

In the step S2102, the public function executing module 201c reads the second job set value corresponding to the identifier received from the image forming apparatus 102 from the storage unit 102b. For example, when the details of the QR code embedding function and the form composing function are being set in the step S1008 or the step S1012, the second job set value as the detailed setting of both the functions is read.

In step S2103, the communication module 201a receives the image data from the image forming apparatus 102.

In step S2104, the public function executing module 201c executes the requested public function based on the second job set value read. For example, when the details of the QR code embedding function and the form composing function are being set in the step S1008 or the step S1012, the processes of the QR code embedding and the form composition are applied to the received image data. Then, the image data processed is stored in the storage unit 101b temporarily.

In step S2105, the communication module 201a sends the image data, which has been processed by the public function, to the image forming apparatus 102.

In step S2106, the communication module 201a determines whether the public function termination request has been received from the image forming apparatus 102. When received, the process finishes. When not received, the process returns to the step S2103.

According to the above-mentioned embodiment, the external apparatus 101 compares the information about the client function received from the image forming apparatus 102 with the information about the public function, selects the public functions of newer versions from among the public functions that overlap with the client functions, and registers the selected public functions into the comparison result list for the image forming apparatus. Then, the external apparatus 101 adds the screen information for setting the details of the public functions obtained from the comparison result by the function comparison module 201e to the comparison result list for the image forming apparatus, and sends it to the image forming apparatus 102. The image forming apparatus 102 displays the setting screen for setting the details of the public functions based on the screen information received from the external apparatus 101 when executing a job. Thus, the more suitable screen can be provided to the user even when a function that can be executed by the image forming apparatus is provided by the linked external apparatus. More specifically, the user can select a screen using a newer function.

Next, a second embodiment of the present invention will be described. In the second embodiment, variations are supplementary described on the basis of the first embodiment.

Although the screen information that the UI providing module 201b provides is premised on the Web page in the above-mentioned first embodiment, it may be another form. For example, it may be image data that can be displayed in VNC (Virtual Network Computing). In this case, the image forming apparatus 102 displays the extension mode setting screen 320, the QR code detailed setting screen 330, and the form composition detailed setting screen 340 by a VNC viewer rather than the Web browser. Instead, the image forming apparatus 102 may display the screens by analyzable forms such as text data and binary data. In this case, the image forming apparatus 102 analyzes texts displayed in the screen and data specifying an image, and displays the texts and the image specified by the analysis.

Although the public function executed by the public function executing module 201c is designated by a URL in the first embodiment, another designation may be employed. For example, it may be designated by a HTTP request. Or, it may be designated by a SOAP request. Or, it may be designated by arguments of a RPC (a remote procedure call).

Although the detailed settings of the public function stored in the storage unit 102b by the public functional information storage module 201d comprises four kinds of information in the first embodiment, other forms are also available. For example, additional information is available and a combination of two or more kinds of information may be stored. The location of the screen information may be designated by another form rather than the first linked URL. For example, the location of the screen information may be designated by the ID for identifying a function uniquely. In such a case, the first linked URL becomes unnecessary.

Although the detailed setting of the public function stored in the storage unit 102b by the public functional information storage module 201d is deleted after a lapse of predetermined time in the first embodiment, another system can be employed. For example, only one detailed setting may be stored with respect to each identifier that identifies the image forming apparatus 102 uniquely, and an old detailed setting may be overwritten by a newer detailed setting. Or, only one detailed setting may be stored with respect to a combination of the identifier that identifies the image forming apparatus 102 uniquely and an identifier that identifies the user who uses the image forming apparatus 102 uniquely, and an old detailed setting may be overwritten by a newer detailed setting. Or, the communicating state with the image forming apparatus 102 is monitored, and all the detailed settings registered from the image forming apparatus 102 may be deleted when the communication breaks. Or, all the detailed settings registered from the image forming apparatus 102 may be deleted at the timing when a condition to clear the setting by the user on the UI control module 202b of the image forming apparatus 102 is satisfied.

Although the external apparatus 101 executes the process shown in FIG. 10 in the above-mentioned embodiment, the image forming apparatus 102 is also able to execute it instead.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-127786, filed on Jun. 3, 2010, which is hereby incorporated by reference herein in its entirety.

What is claimed is:

1. An image forming system comprising:
an external apparatus provided with first functions comprising:
a comparison unit configured to compare information about the first functions with information about second functions with which an image forming apparatus is provided;
a determination unit configured to determine functions to be used by the image forming apparatus among the first functions based on a comparison result by said comparison unit; and
a screen information sending unit configured to send screen information that is used for setting the functions determined by said determination unit to the image forming apparatus,
the image forming apparatus capable of connecting to the external apparatus via a network, comprising:
a functional information sending unit adapted to send the information about the second function with which the image forming apparatus is provided to the external apparatus; and
a display unit adapted to display a setting screen for setting the first functions based on the screen information received from the external apparatus.

2. The image forming system according to claim 1, wherein the external apparatus further comprising:
an issuing unit adapted to issue an identifier for identifying a user who uses the first functions; and
a registration unit adapted to register the first functions that do not correspond to the second functions based on the comparison result by said comparison unit and the functions determined by said determination unit in association with the identifiers issued by said issuing unit.

3. The image forming system according to claim 1, wherein identifier is given to each of the first and second functions, and
wherein said comparison unit compares the identifiers of the second functions with the identifiers of the first functions, and determines whether there is a second function of which identifier agrees with one of the identifiers of the first functions.

4. The image forming system according to claim 1, wherein said display unit displays a detailed setting screen for setting a function that is available in the image forming apparatus, and displays a setting screen for setting details of the functions that is determined by said determination unit according to an instruction by a user on the detailed setting screen.

5. The image forming system according to claim 1, wherein said determination unit determines to make the first function be used in the image forming apparatus, when a version of the first function is newer than a version of the second function of the same kind as the first function.

6. A control method for an image forming system comprising:
a comparison step, executed by an external apparatus that is provided with first functions, of comparing information about the first functions with information about second functions with which an image forming apparatus is provided;
a determination step, executed by the external apparatus, of determining functions to be used by the image forming apparatus among the first functions based on a comparison result in said comparison step;
a screen information sending step, executed by the external apparatus, of sending screen information that is used for setting the functions determined in said determination step to the image forming apparatus;
an information sending step, executed by the image forming apparatus, of sending the information about the second function with which the image forming apparatus is provided to the external apparatus; and
a display step, executed by the image forming apparatus, of displaying a setting screen for setting the first functions based on the screen information received from the external apparatus.

7. A non-transitory computer-readable storage medium storing a control program causing one of the image forming apparatus and the external apparatus to execute the control method according to claim 6.

8. An external apparatus provided with first functions comprising:
a comparison unit configured to compare information about the first functions with information about second functions with which an image forming apparatus is provided;
a determination unit configured to determine functions to be used by the image forming apparatus among the first functions based on a comparison result by said comparison unit; and
a screen information sending unit configured to send screen information that is used for setting the functions determined by said determination unit to the image forming apparatus.

9. An information processing apparatus provided with public functions that can be used by another apparatus and capable of communicating via a network with an image forming apparatus that can singly provide client functions to a user, comprising:
a comparison unit configured to compare information about the public functions with information about the client functions received from the image forming apparatus;
a registration unit configured to register a first public function of a newer version among the public functions corresponding to the client functions based on the comparison result by said comparison unit; and
a screen information sending unit configured to add screen information for setting details of the first public function to the information about the first public function registered by said registration unit, and to send it to the image forming apparatus.
